(19) United States
(12) Patent Application Publication
(10) Pub. No.: US 2014/0002839 A1
(43) Pub. Date: Jan. 2, 2014

(54) PRINTING SYSTEM, INFORMATION PROCESSING APPARATUS, PRINTING APPARATUS, CONTROL METHOD, AND STORAGE MEDIUM STORING PROGRAM THEREOF

(71) Applicant: CANON KABUSHIKI KAISHA, TOKYO (JP)

(72) Inventor: Hiroto Tsujii, Kawasaki-shi (JP)

(21) Appl. No.: 13/911,892

(22) Filed: Jun. 6, 2013

(30) Foreign Application Priority Data
Jun. 28, 2012 (JP) 2012-146081

(51) Int. Cl. G06F 3/12

(52) U.S. Cl. CPC G06F 3/1292
USPC 358/1.13; 358/1.15

(57) ABSTRACT

In a printing system which includes a mobile terminal, information processing apparatus, and printing apparatus, the printing apparatus prints based on a file attached to an e-mail transmitted from the mobile terminal. The information processing apparatus expands the attached file, generates print data by using a printer driver corresponding to the printing apparatus, adds the e-mail address of the transmission source of the e-mail to the print data, and transmits the print data to the printing apparatus. The printing apparatus adds the e-mail address to the name of the print data, and displays a printing status in the printing apparatus.

### BACKGROUND OF THE INVENTION

1. Field of the Invention

The present invention relates to a printing system which prints in accordance with e-mail from a mobile terminal, an information processing apparatus, a printing apparatus, a control method, and a storage medium storing a program thereof.

2. Description of the Related Art

Conventionally, when printing from a mobile terminal, a file the user wants to print is attached to e-mail by using e-mail software of the mobile terminal, and is transmitted to a printer to print it (Japanese Patent Laid-Open No. 2004-220606). In this case, an e-mail address is assigned in advance to a printer, file-attached e-mail is transmitted to the e-mail address, and the printer prints the contents of the attached file. There is also proposed a technique of installing a dedicated adaptor between a server and a printer and printing a file attached to e-mail from a mobile terminal (Japanese Patent Laid-Open No. 2001-312392).

At present, by applying the above techniques, a printer driver corresponding to each printer is installed in advance in a print server. The print server activates application software corresponding to the extension of a file attached to received e-mail, and prints.

However, in this technique, only the print server transfers print data to a printer. Even if a user who executed printing is confirmed from the printing status and printing result of the printer which executed printing, only the print server is displayed. It is therefore difficult for the user to confirm the printing history and printing status of print data printed by himself.

### SUMMARY OF THE INVENTION

An aspect of the present invention is to eliminate the above-mentioned problems with the conventional technology.

The present invention provides a technique which allows the user to easily confirm the printing status of his print data from information displayed on a printing apparatus.

The present invention in its first aspect provides a printing system comprising an information processing apparatus and a printing apparatus, the printing apparatus printing based on a file attached to an e-mail transmitted from a mobile terminal, the information processing apparatus including: a reception unit configured to receive the e-mail transmitted from the mobile terminal; a generation unit configured to generate print data corresponding to a file attached to the e-mail received by the reception unit; an extraction unit configured to extract an e-mail address of a transmission source of the e-mail; and a transmission unit configured to add the e-mail address extracted by the extraction unit to the print data and transmit the print data as a print job to the printing apparatus, and the printing apparatus including a display control unit configured to display a printing status in the printing apparatus based on the e-mail address.

According to the present invention, the user can easily confirm the printing status of his print data from information displayed on a printing apparatus.

Further features of the present invention will become apparent from the following description of exemplary embodiments with reference to the attached drawings.

### BRIEF DESCRIPTION OF THE DRAWINGS

FIG. 1 is a view for explaining a printing system according to an embodiment of the present invention;

FIG. 2 is a block diagram showing the arrangement of an access point according to the embodiment of the present invention;

FIG. 3 is a block diagram showing the arrangement of a mail server and print server according to the embodiment;

FIG. 4 is a block diagram for explaining the arrangement of a printing apparatus according to the embodiment;

FIG. 5 is a view for explaining transmission of e-mail from a mobile terminal to the print server in the embodiment;

FIG. 6 is a flowchart for explaining processes by the mobile terminal, AP, servers, and printing apparatus in a print processing sequence in the printing system according to the embodiment;

FIG. 7 is a flowchart for explaining processing by the print server according to the first embodiment;

FIG. 8 is a table showing a list of file types and applications supported by the print server according to the embodiment;

FIG. 9 is a table exemplifying a table which stores the correspondence between the name of a printer and a printer driver for the printer;

FIG. 10 is a table exemplifying display of a general printing status;

FIG. 11 is a table exemplifying display of a printing status displayed on the display unit of the operation unit of the printing apparatus according to the first embodiment;

FIG. 12 is a flowchart for explaining processing by a print server according to the second embodiment; and

FIG. 13 is a table exemplifying display of a printing status displayed on the display unit of the operation unit of a printing apparatus according to the second embodiment.

### DESCRIPTION OF THE EMBODIMENTS

Preferred embodiments of the present invention will now be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention.

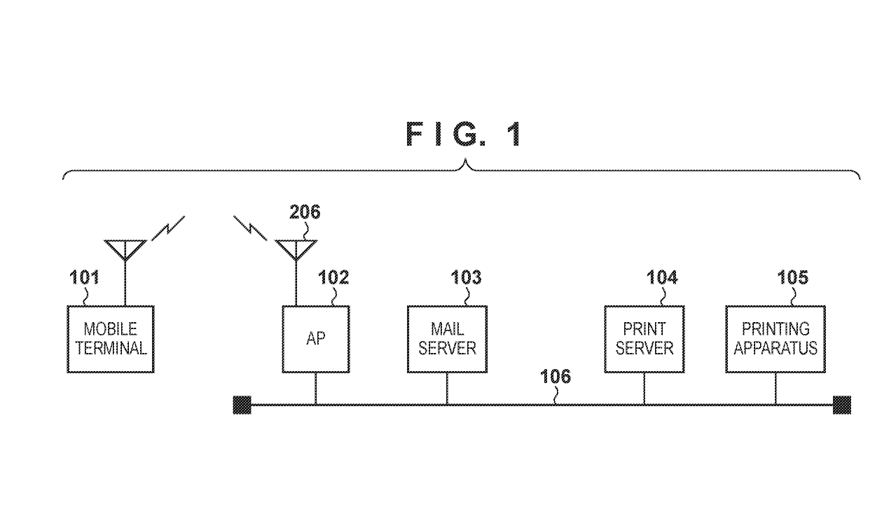

FIG. 1 is a view for explaining a printing system according to an embodiment of the present invention.

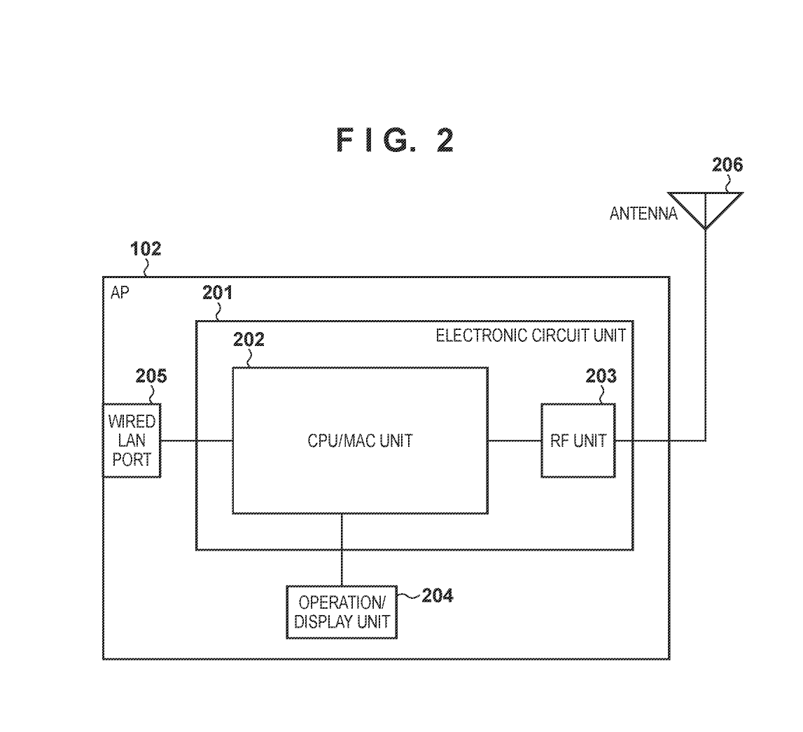

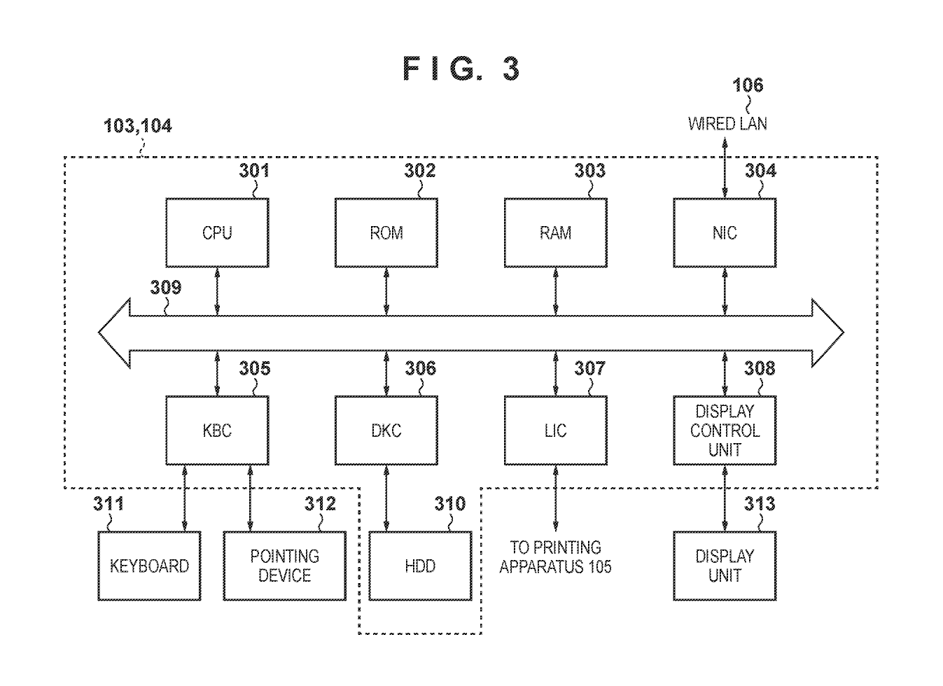

A mobile terminal 101 is an information terminal device having a size enough to be carried with a hand, in which an operating system (to be referred to as an OS hereinafter) is installed and various application software programs can run on the OS. In the embodiment, e-mail software serving as one application software of the mobile terminal 101 transmits e-mail by wireless communication. An access point (to be referred to as an AP hereinafter) 102 is an apparatus which can connect the mobile terminal 101 to a wired LAN (Local Area Network) 106 via wireless communication. The internal arrangement of the AP 102 will be explained in detail with reference to FIG. 2. A mail server 103 is formed from an information processing apparatus such as a general personal computer (to be referred to as a PC hereinafter). The mail server function is obtained by installing mail server software in the mail server 103 and operating it. The arrangement of the mail server 103 will be explained in detail with reference to FIG. 3. E-mail transmitted from the mobile terminal 101 is sent to the mail server 103 via the AP 102 and held.

A print server 104 is also formed from an information processing apparatus such as a general PC, similar to the mail server 103. The arrangement of the print server 104 will also be explained with reference to FIG. 3. Printer drivers for a plurality of printing apparatuses connected via the wired LAN 106 are installed in the print server 104. A printing apparatus 105 prints an image on paper based on print data in accordance with a print instruction from the print server 104. The wired LAN 106 connects the AP 102, mail server 103, print server 104, and printing apparatus 105 by, for example, an Ethernet® cable, forming a network. Although the print server 104 and printing apparatus 105 are connected via the wired LAN 106 in FIG. 1, the present invention is not limited to this. For example, the print server 104 and printing apparatus 105 may be connected via an interface such as a USB interface. In the embodiment, the print server and mail server are formed from separate information processing apparatuses, but may be formed from a single information processing apparatus. That is, the information processing apparatus may have a mail server function, mail client function, and printer control function to be described later.

FIG. 2 is a block diagram showing the arrangement of the AP 102 according to the embodiment of the present invention. The AP 102 can wirelessly communicate with an apparatus (for example, the mobile terminal 101) connected to a wireless communication network, and can communicate with the mail server 103 and print server 104 via the wired LAN 106.

The AP 102 includes an electronic circuit unit 201, operation/display unit 204, and wired LAN port 205. The wired LAN port 205 has a connector connectable to an Ethernet® cable to connect the AP 102 to the wired LAN 106. The operation/display unit 204 includes a display unit, various key switches, and the like, and displays the state of the main body of the AP 102 and the state of each port. The operation/display unit 204 also includes a switch for connection to a wireless LAN. The AP 102 also has a security function for safely performing wireless LAN connection.

The AP 102 includes a CPU/MAC unit 202 and a radio frequency transmission/reception unit (to be referred to as an RF unit hereinafter) 203. The CPU/MAC unit 202 incorporates a CPU (not shown) and MAC (Media Access Control) (not shown). The CPU includes devices such as a processor and memory, and these devices are connected to each other via a bus (not shown). The MAC includes a portion for performing wireless communication, and a portion for performing wired communication. As shown in FIG. 2, both the CPU/MAC unit 202 and RF unit 203 are mounted on the electronic circuit unit 201. An antenna 206 is attached to the RF unit 203 to transmit/receive a radio wave. The CPU/MAC unit 202 is connected to the operation/display unit 204, RF unit 203, and wired LAN port 205. The AP 102 is connected to the wired LAN 106 via the Ethernet® cable (not shown). The Ethernet® cable is connected at one end to the wired LAN port 205, and connected at the other end to a network hub (not shown).

FIG. 3 is a block diagram showing the arrangement of the mail server 103 and print server 104 according to the embodiment.

In each server, a CPU 301, ROM 302, RAM 303, and network interface controller (NIC) 304 are connected via a bus 309. Also, a keyboard controller (KBC) 305, disk controller (DKC) 306, local interface controller (LIC) 307, and display control unit 308 are also connected via the bus 309. An Ethernet® cable which connects the server to the wired LAN 106 is connected to the NIC 304.

A keyboard 311 and pointing device 312 are connected to the KBC 305. A hard disk drive (HDD) 310 is connected to the DKC 306. A peripheral device is connected to the LIC 307 via a local interface such as a USB interface. A display unit 313 such as a liquid crystal display is connected to the display control unit 308. The ROM 302 stores a basic I/O program, operating system (OS), and the like. The CPU 301 manages and executes an application program based on execution of the OS.

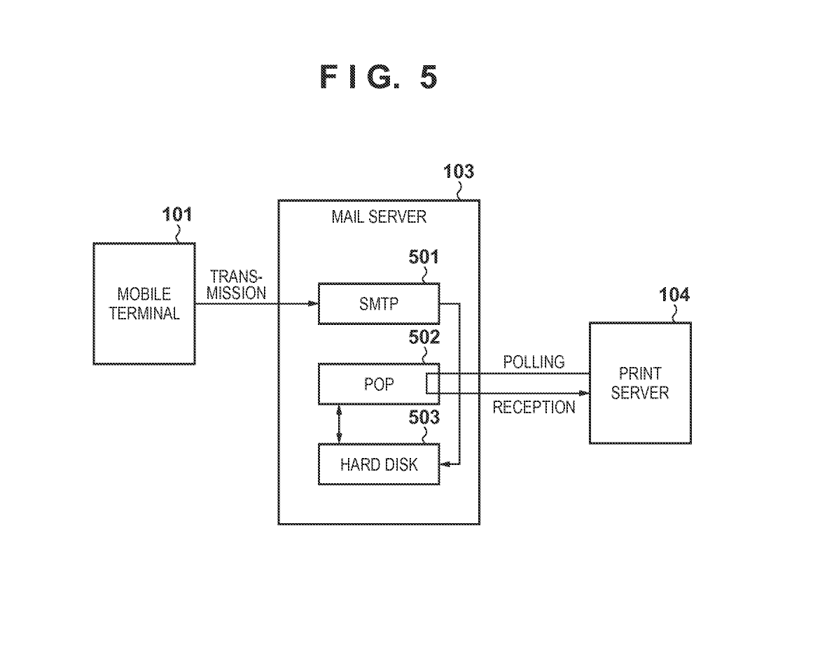

In the print server 104, the HDD 310 stores the printing application of the mobile terminal 101 according to the embodiment, various application programs, and a printer driver corresponding to the printing apparatus 105. The print server 104 has a mail client function and printer control function, and implements a printing function for a file attached to e-mail by using these functions. Note that the mail server function of the mail server 103 will be described later with reference to FIG. 5.

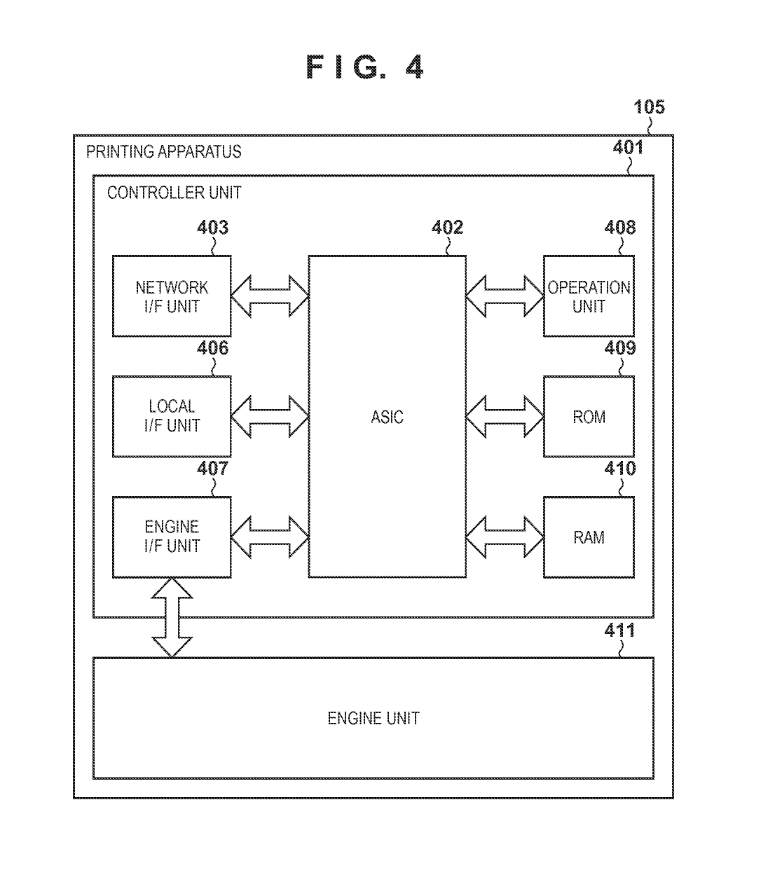

FIG. 4 is a block diagram for explaining the arrangement of the printing apparatus 105 according to the embodiment.

A controller unit 401 includes a network interface (I/F) unit 403, local interface unit 406, and engine interface unit 407, and processes received print data. An ASIC 402 incorporates a CPU (not shown), and mainly performs processing of transferring print data to an engine unit 411. Also, the controller unit 401 includes an operation unit 408 which notifies the user of the status of the printing apparatus 105 and allows the user to input an operation, a ROM 409 which stores programs and the like, and a RAM 410 which provides an image data rasterization area and program work area when processing print data. The network interface unit 403 and local interface unit 406 transmit/receive data to/from a PC via an external interface. The external interface assumes an Ethernet® interface, USB interface, or the like. The engine interface unit 407 outputs print data from the controller unit 401 to the engine unit 411 to print it.

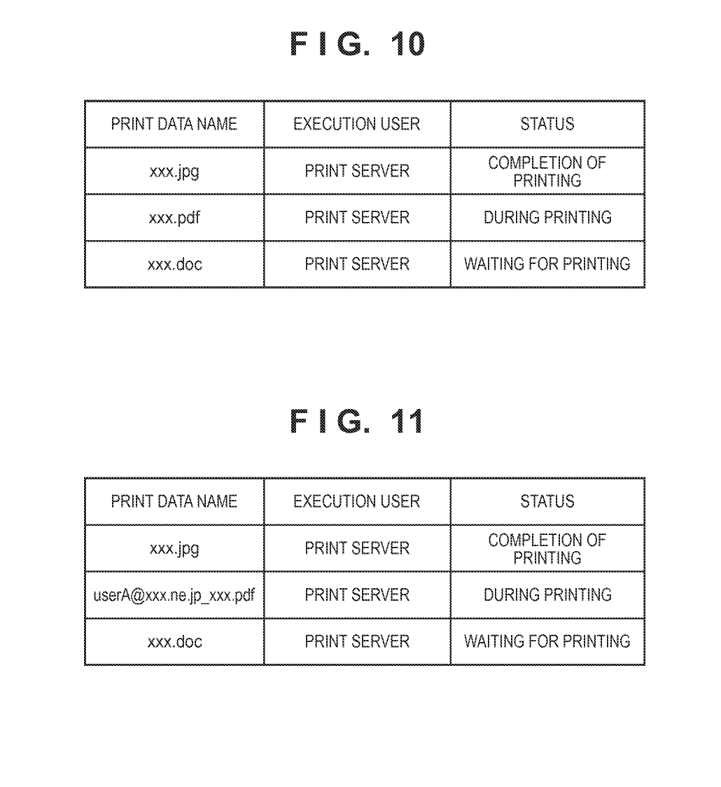

The printing apparatus 105 receives print data sent from a host computer represented by the mail server 103 or print server 104 via the network interface unit 403, local interface unit 406, and the like. The CPU of the ASIC 402 rasterizes the received print data, and bitmap image data generated by rendering processing is stored in the image spool area of the RAM 410. The engine interface unit 407 transfers the bitmap image data stored in the image spool area of the RAM 410 to the engine unit 411 in synchronism with the engine unit 411. The engine unit 411 prints on paper in accordance with the bitmap image data sent via the engine interface unit 407. The CPU of the ASIC 402 links the print data name, execution user information, and print processing execution status (for example, during printing or waiting for printing), and saves them in the RAM 410. Although not shown, the operation unit 408 includes a display unit (not shown) for displaying items as shown in FIGS. 10, 11, and 13. The user can confirm a print processing status from contents displayed on the display unit.

FIG. 5 is a view for explaining transmission of e-mail from the mobile terminal 101 to the print server 104 in the embodiment.

First, the function of the mail server 103 will be explained. In the mail server 103, an SMTP (Simple Mail Transfer Protocol) server 501 and POP (Post Office Protocol) server 502 run and perform different operations. The functions of the SMTP server 501 and POP server 502 are implemented by expanding, in the RAM 303, programs stored in the ROM 302 (FIG. 3) or the HDD 310, and executing them by the CPU 301. In a connected network or intranet, the SMTP server 501 operates based on an e-mail transmission protocol, and the POP server 502 operates based on an e-mail reception protocol. The mobile terminal 101 transmits e-mail by e-mail software installed in it. The transmitted e-mail is sent via the AP 102 to the mail server 103 connected to the wired LAN 106. At this time, the e-mail software of the mobile terminal 101 designates a predetermined mail address (destination) of the print server 104. The mail address is, for example, “printserver@mailprint.xxx.jp”.

The mail server 103 connected to the wired LAN 106 receives, via the AP 102, the e-mail transmitted from the mobile terminal 101. Upon receiving the e-mail, the mail server 103 ensures a mail save area for the print server 104 in a hard disk 503 (corresponding to the HDD 310), stores the e-mail, and ends the operation. Next, an operation of receiving e-mail by the print server 104 from the mail server 103 will be explained. The print server 104 performs polling reception to inquire, of the POP server 502 of the mail server 103, whether e-mail has been received, as instructed by a mobile cooperative printing application according to the embodiment. At this time, the print server 104 designates a predetermined mail address (destination). The polling interval can be arbitrarily set by the mobile cooperative printing application according to the embodiment.

The POP server 502 requests a user name and password for an access from the print server 104. If it is confirmed that the user name and password are correct, the POP server 502 checks accumulated received mail messages, and sends back the presence/absence of e-mail addressed to the print server 104. If received e-mail exists in the POP server 502, the POP server 502 delivers the e-mail to the print server 104 and ends the processing.

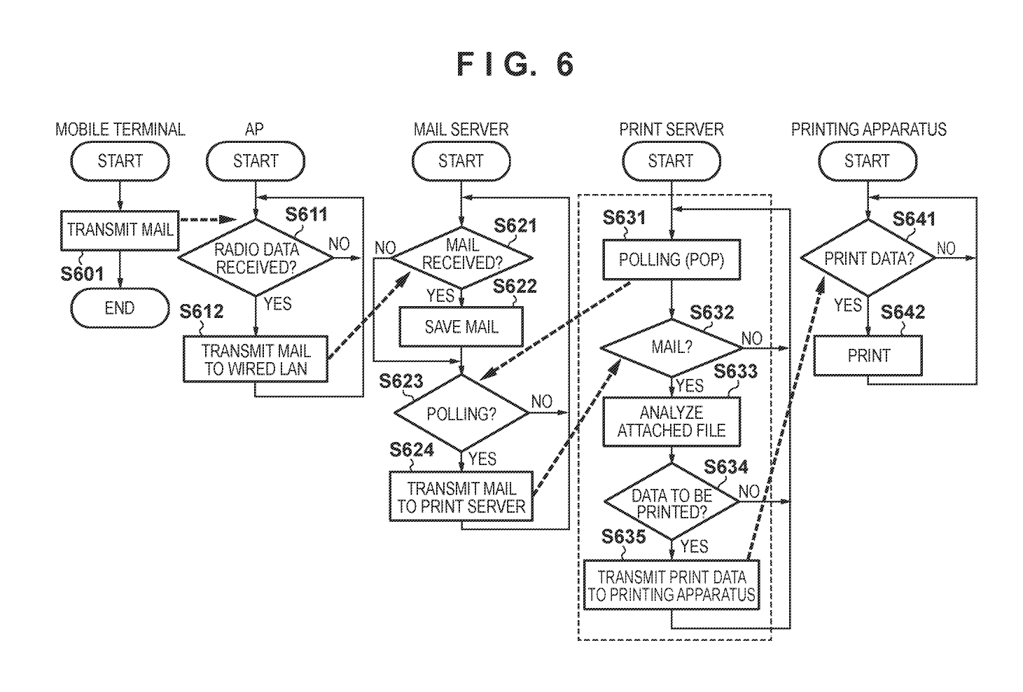

FIG. 6 is a flowchart for explaining processes by the mobile terminal, AP, servers, and printing apparatus in a print processing sequence in the printing system according to the embodiment. FIG. 6 shows an overall sequence from transmission of e-mail by the mobile terminal 101 up to printing of an attached file by the printing apparatus 105. Note that the respective processes are achieved by executing various application programs stored in the memories or HDDs of the respective devices by their CPUs.

In step S601, the e-mail software of the mobile terminal 101 of the user transmits e-mail by attaching a file he designates and wants to print. At this time, the printer name of a printer which is to print is described in the subject box of the e-mail (for example, the subject box of a mail header defined by MIME). The transmission unit in this case is a wireless LAN. The e-mail software of the mobile terminal 101 ends its operation.

In step S611, the AP 102 receives the e-mail from the mobile terminal 101 as radio data via the wireless LAN. More specifically, the radio signal is input from the antenna 206, and converted from an analog signal into a digital signal by the RF unit 203. At the subsequent stage, the CPU/MAC unit 202 analyzes the destination and route from the digital signal, and transmits the digital signal to the wired LAN 106 via the wired LAN port 205. In this manner, the AP 102 transmits the e-mail to the mail server 103 (SMTP server 501 in FIG. 5) via the wired LAN 106 in step S612.

If the mail server 103 receives the e-mail in step S621, the process advances to step S622, and the mail server 103 stores the e-mail in the HDD 310 together with the attached file.

In step S631, the print server 104 polls the POP server 502 of the mail server 103 at a predetermined time interval. Details of this operation have been described with reference to FIG. 5.

If the mail server 103 confirms polling and confirms the presence of new mail in step S623, the process advances to step S624, and the mail server 103 transmits the e-mail and its attached file to the print server 104 (POP server 502).

If the print server 104 receives the e-mail in step S632, the process advances to step S633, and the print server 104 analyzes the file attached to the e-mail. Note that data to be handled is called an “attached file” until the print server 104 analyzes the file in step S633. Data rasterized into data to be printed after the print server 104 analyzes the attached file in step S633 is called “print data”. The process advances to step S634, and the print server 104 determines based on the result of analysis in step S633 whether the file attached to the received e-mail is data to be printed. If the attached file is data to be printed, the process advances to step S635. In step S635, the print server 104 checks the extension of the attached file, activates an application stored in the HDD 310 of the print server 104, generates print data by using the printing function of the application, and transmits the print data to the printing apparatus 105.

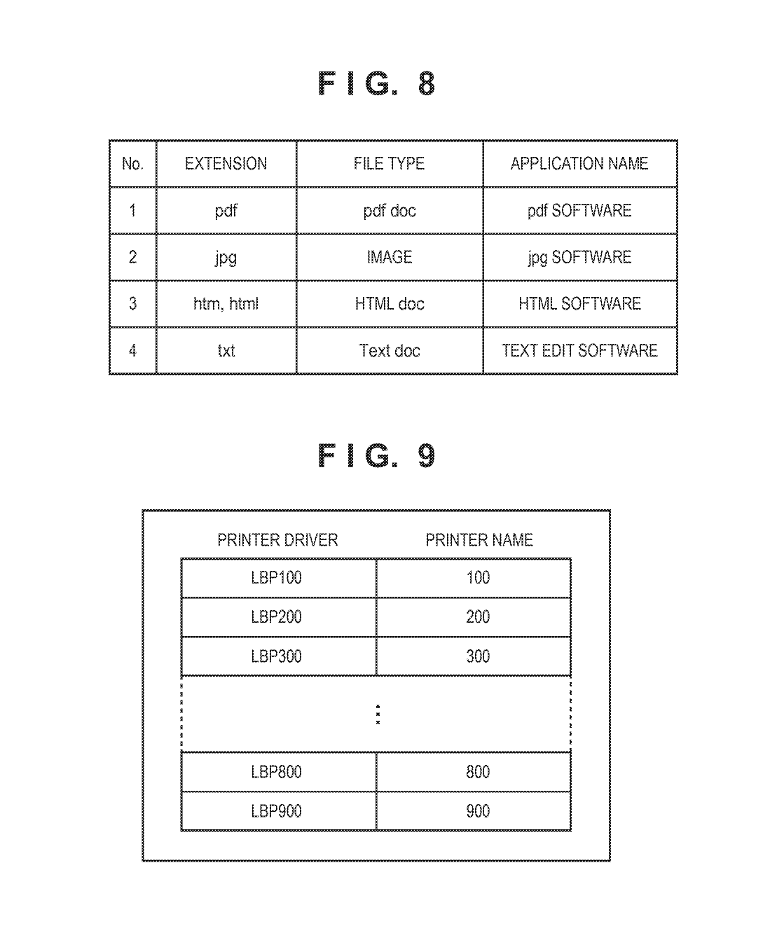

FIG. 8 is a table showing a list of file types and applications supported by the print server 104 according to the embodiment.

An extension, its file type, and the name of an application which handles the file are registered in association with each other. The correspondence between the extension of a file attached to e-mail and an application in the print server 104 is determined in advance. The printing function of an application corresponding to an extension can be activated to create print data.

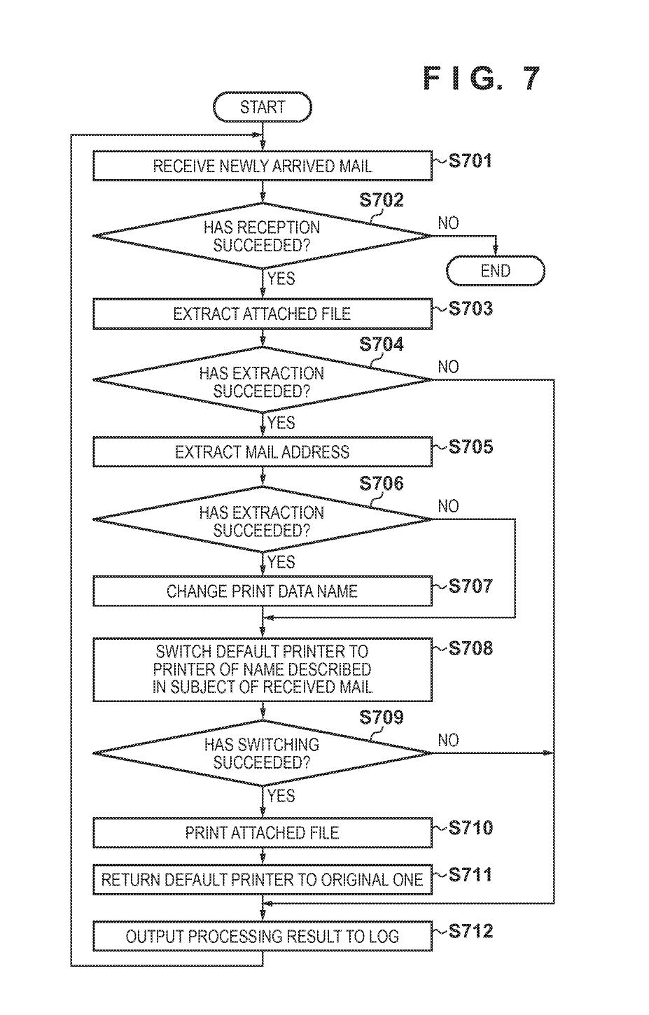

Note that steps S631 to S635 (surrounded by a dotted line in FIG. 6) will be explained in detail with reference to the flowchart of FIG. 7.

If the printing apparatus 105 receives the print data from the print server 104 in step S641, it prints on paper based on the print data in step S642, and ends the sequence.

FIG. 7 is a flowchart for explaining processing by the print server 104 according to the first embodiment of the present invention. Note that a program which executes this processing is stored in the ROM 302 and executed under the control of the CPU 301 of the print server 104. FIG. 7 shows processing from step S631 to step S635 by the print server 104, which has been described with reference to FIG. 6.

In step S701, the CPU 301 of the print server 104 (to be simply referred to as the CPU 301 hereinafter) receives e-mail from the mail server 103 (polling by POP). The process advances to step S702, and the CPU 301 determines whether the reception of the mail has succeeded, and if normal reception of the e-mail has failed, ends the processing. If the CPU 301 determines in step S702 that the e-mail has been received normally, the process advances to step S703, and the CPU 301 extracts a file (attached file) attached to the e-mail. In step S704, the CPU 301 determines whether the extraction of the attached file has succeeded. If the extraction of the attached file has succeeded, the CPU 301 controls the DKC 306 via the bus 309 to store the extracted attached file in the HDD 310. If the extraction of the attached file has failed in step S704, the process advances to step S712, and the CPU 301 controls the display control unit 308 to display the processing result log on the display unit 313. At the same time, the CPU 301 stores the processing result log in the HDD 310. The user can use the processing result log for troubleshooting.

If the CPU 301 determines in step S704 that the attached file has been extracted, the process advances to step S705, and the CPU 301 extracts the e-mail address (for example, userA@xxx.ne.jp) of the transmission source of the received e-mail. In step S706, the CPU 301 determines whether the extraction of the e-mail address of the transmission source has succeeded, and if it has succeeded, stores the mail address in the RAM 303. Then, the process advances to step S707, and the CPU 301 reads out the extracted e-mail address of the transmission source from the RAM 303, and changes the print data name by adding the e-mail address of the transmission source to the file name of the attached file stored in the HDD 310. The process then advances to step S708. Also, if the extraction of the e-mail address of the transmission source has failed in step S706, the process advances to step S708. Note that the change of the print data name in step S707 will be described with reference to FIGS. 10 and 11.

FIG. 10 is a table exemplifying display of a general printing status. In this case, the name of print data (print data name), an execution server (print server) which designates printing, and a printing status (status) in the printing apparatus are displayed in association with each other. The status includes “completion of printing”, “during printing”, and “waiting for printing”.

FIG. 11 is a table exemplifying display of a printing status displayed on the display unit of the operation unit of the printing apparatus 105 according to the first embodiment.

As is apparent from FIG. 11, the user mail address “userA@xxx.ne.jp” is added to the print data name “xxx.pdf” and displayed. From the print data name, the user can easily confirm that the print data is data attached to e-mail transmitted by himself, and the status is “during printing”. Note that an example of displaying a mail address in addition to a print data name is not limited to the example of FIG. 11. Another display method of, for example, adding a mail address to the second half of a file name may be used. Information to be added may be not an entire mail address but only a part before @ of the mail address. That is, adding a mail address to a print data name includes all such modifications.

After that, the process advances to step S708, and the CPU 301 switches the printer driver setting from a default printer to a printer described in the subject of the received e-mail. In step S709, the CPU 301 determines whether the default printer switching has succeeded. If the switching has succeeded, the process advances to step S710. If the switching has failed in step S709 (for example, the designated printer driver does not exist), the process advances to step S712, and the CPU 301 controls the display control unit 308 to display the processing result log on the display unit 313. At the same time, the CPU 301 stores the processing result log in the HDD 310.

In step S710, the CPU 301 looks up the table shown in FIG. 8, and activates the printing function of an application corresponding to the extension of the file attached to the e-mail. By looking up a table in FIG. 9, the CPU 301 activates a printer driver liked to the name of a printer which is to print. Then, the CPU 301 rasterizes the print data in the RAM 303, and outputs it to the printing apparatus 105 designated by the subject of the e-mail. Note that the table which links a printer driver and “printer name” in the subject of e-mail can be, for example, a table as shown in FIG. 9.

FIG. 9 is a table exemplifying a table which stores the correspondence between the name of a printer and a printer driver for the printer.

When a new printer is connected to the wired LAN 106 or connected to the local interface of the print server 104, the CPU 301 of the print server 104 adds information about the printer driver and printer name to this table. Note that the printer name is an example of an identifier for specifying a printer, and another information such as an IP address may be used as long as it is information capable of specifying a printer. In this case, the table in FIG. 9 manages the information such as an IP address in association with a printer driver.

If printing of the attached file ends in step S710, the process advances to step S711, and the CPU 301 returns the default printer setting to the original one. The process advances to step S712, and the CPU 301 outputs the processing result to the log, and controls the display control unit 308 to display the processing result log on the display unit 313. At the same time, the CPU 301 stores the processing result log in the HDD 310.

As described above, the print server 104 according to the first embodiment adds the e-mail address of a transmission source to the name of print data, and transmits the print data to the printing apparatus 105. When the user confirms a printing execution status on the display unit of the operation unit 408 of the printing apparatus 105, he can easily determine that this printing execution status is the printing status of his print data because his mail address is added to the name of the print data.

The communication unit which transmits e-mail from the mobile terminal 101 is the wireless LAN, but may be a mobile phone terminal though not shown. Even if the mobile terminal 101 attaches a plurality of files to e-mail, this does not restrict the functions of the embodiment though not shown.

### Second Embodiment

The second embodiment according to the present invention will be described. The arrangements of a printing system, mobile terminal, AP, server, printing apparatus, and the like according to the second embodiment are the same as those in the first embodiment, and a description thereof will not be repeated.

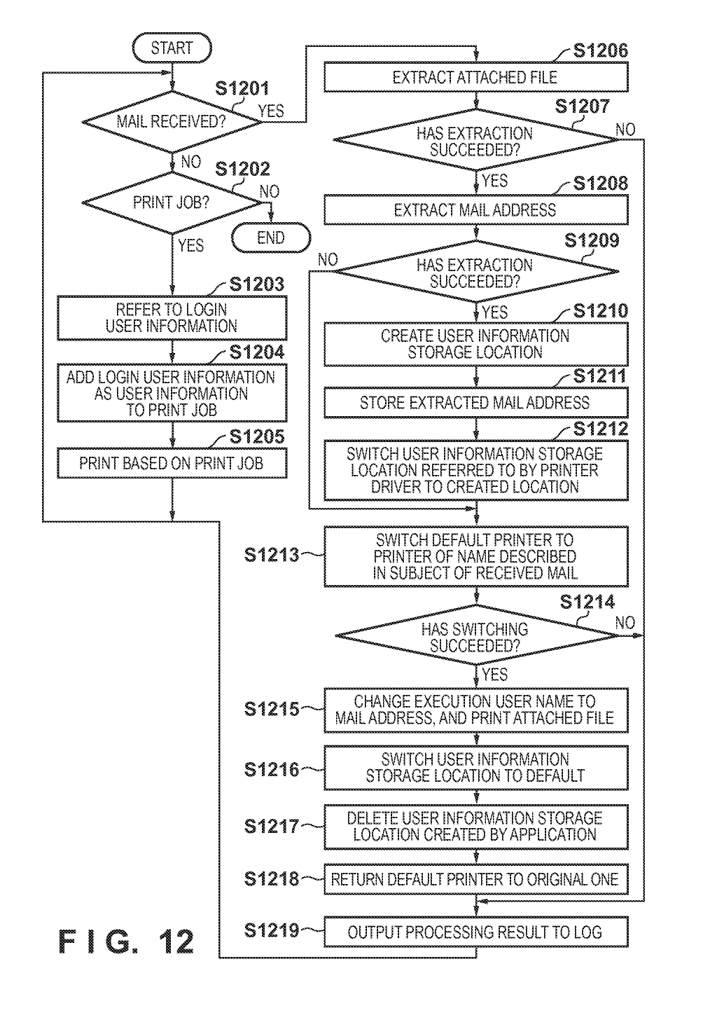

FIG. 12 is a flowchart for explaining processing from step S631 to step S635 in FIG. 6 by a print server 104 according to the second embodiment of the present invention. Note that a program which executes this processing is stored in a ROM 302 of the print server 104, and executed under the control of a CPU 301 of the print server 104.

In step S1201, the CPU 301 of the print server 104 (to be simply referred to as the CPU 301 hereinafter) determines whether it has received e-mail from a mail server 103. If no e-mail has not been received in step S1201, the process advances to step S1202, and the CPU 301 determines whether there is a print job. If the CPU 301 determines in step S1202 that there is no print job, the process ends. If the CPU 301 determines that there is a print job, the process advances to step S1203, and the CPU 301 refers to login user information of a user who has logged in to the print server 104. The process advances to step S1204, and the CPU 301 adds the login user information referred to in step S1203 as a printing execution user to the print job. The process advances to step S1205, and the CPU 301 outputs the print job to a printing apparatus 105 to print. If the printing execution status is confirmed, the display unit of an operation unit 408 displays a screen shown in FIG. 10.

If e-mail has been received in step S1201, the process advances to step S1206, and the CPU 301 extracts an attached file. In step S1207, the CPU 301 determines whether the extraction has succeeded. If the extraction has succeeded, the CPU 301 controls a DKC 306 via a bus 309, and stores the attached file in an HDD 310. If the extraction of the attached file has failed in step S1207, the process advances to step S1219, and the CPU 301 controls a display control unit 308 to display the processing result log on a display unit 313 and store it in the HDD 310. The user can use later the processing result log for troubleshooting.

If the extraction of the attached file has succeeded in step S1207, the process advances to step S1208, and the CPU 301 extracts the e-mail address (for example, userA@xxx.ne.jp) of the transmission source of the received e-mail. In step S1209, the CPU 301 determines whether the extraction of the e-mail address of the transmission source has succeeded. If the extraction of the e-mail address of the transmission source has succeeded, the process advances to step S1210; if it has failed in step S1209, to step S1213. In step S1210, the CPU 301 ensures, in a RAM 303, an area for storing execution user information. After that, the process advances to step S1211, and the CPU 301 stores the extracted mail address of the transmission source in the execution user information storage location created in step S1210. The process advances to step S1212, and the CPU 301 switches, to the user information storage area created in step S1210, the user information reference location to be added to print data as an execution user by the printer driver. The process advances to step S1213, and the CPU 301 switches the printer driver setting from a default printer to a printer described in the subject of the received e-mail. In step S1214, the CPU 301 determines whether the switching of the default printer setting has succeeded. If the switching has failed (for example, the designated printer driver does not exist), the process advances to step S1219. In step S1219, the CPU 301 controls the display control unit 308 to display the processing result log on the display unit 313 and store the processing result log in the HDD 310.

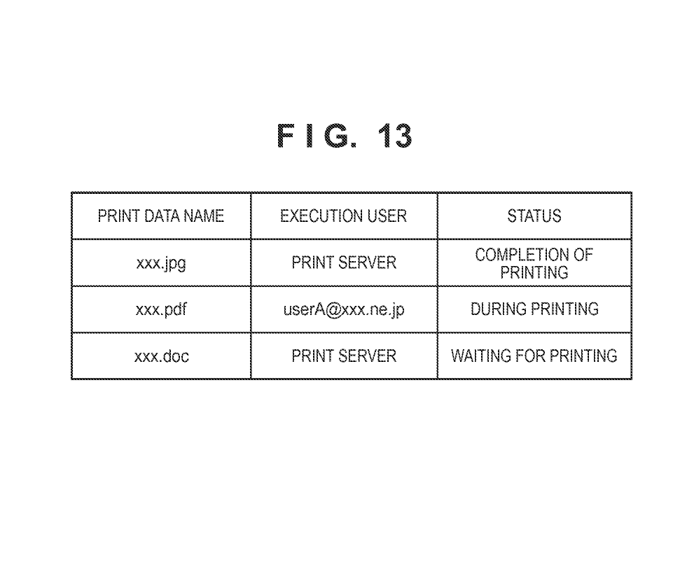

If the switching of the default printer setting has succeeded in step S1214, the process advances to step S1215. In step S1215, the CPU 301 checks the extension of the attached file, activates an application stored in the HDD 310 of the print server 104, and prints the attached file by using the printing function of the application. When transmitting the print data to the printing apparatus 105, the CPU 301 refers to the user information storage area, and sets the execution user information as the e-mail address of the transmission source. That is, in step S1203, the CPU 301 refers to the login user information of the user who has logged in to the print server 104, and adds the login user as an execution user to the print job. To the contrary, in step S1215, the CPU 301 refers to the newly created user information storage area, and adds, as execution user information to the print job, the e-mail address of the transmission source stored there. Accordingly, the e-mail address of the mobile terminal 101 serving as the transmission source of the e-mail is displayed as the execution user, as shown in FIG. 13. Note that an example of displaying a mail address in the execution user field is not limited to the example of FIG. 13. Another display method of, for example, adding printing method information such as “mobile printing” may be used. Information displayed in the execution user field may be not an entire mail address but only a part before @ of the mail address. That is, a mail address displayed instead of a print server displayed in the execution user field includes all such modifications.

In step S1216, after printing the attached file, the CPU 301 returns the user information reference location referred to by the printer driver to the location before switching in step S1212. The process advances to step S1217, and the CPU 301 deletes the user information storage area created in step S1210. The process advances to step S1218, and the CPU 301 returns the default printer setting to the original one. The process then advances to step S1219, and the CPU 301 controls the display control unit 308 to display the processing result log on the display unit 313. At the same time, the CPU 301 stores the processing result log in the HDD 310.

As described above, according to the second embodiment, the print server 104 changes, to the e-mail address of the transmission source, the execution user who executed printing of print data, and transmits the e-mail address of the transmission source to the printing apparatus 105. When the user confirms a printing execution status on the display unit of the operation unit 408 of the printing apparatus 105, he can easily confirm that this printing execution status is the printing status of his print data because the execution user name is displayed by his mail address.

FIG. 13 is a table exemplifying display of a printing status displayed on the operation unit of the printing apparatus 105 according to the second embodiment.

In FIG. 13, the mail address “userA@xxx.ne.jp” of a user who transmitted print data is displayed as the execution user. From this, the user can easily grasp that the printing status of print data having a print data name “xxx.pdf” output by himself is “during printing”.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-146081, filed Jun. 28, 2012, which is hereby incorporated by reference herein in its entirety.

What is claimed is:

1. A printing system comprising an information processing apparatus and a printing apparatus, said printing apparatus printing based on a file attached to an e-mail transmitted from a mobile terminal,
said information processing apparatus including:
a reception unit configured to receive the e-mail transmitted from the mobile terminal;
a generation unit configured to generate print data corresponding to a file attached to the e-mail received by said reception unit;
an extraction unit configured to extract an e-mail address of a transmission source of the e-mail; and
a transmission unit configured to add the e-mail address extracted by said extraction unit to the print data and transmit the print data as a print job to said printing apparatus, and
said printing apparatus including a display control unit configured to display a printing status in said printing apparatus based on the e-mail address.

2. The system according to claim 1, wherein said display control unit adds the e-mail address to a name of the print data, and displays the printing status in said printing apparatus.

3. The system according to claim 1, wherein said display control unit displays the e-mail address instead of displaying user information of a user who logs in to said information processing apparatus.

4. The system according to claim 1, wherein said generation unit activates an application corresponding to an extension of the attached file, and expands the attached file.

5. The system according to claim 1, wherein
said information processing apparatus further includes a table configured to store a printer driver corresponding to each printing apparatus, and
said generation unit activates the printer driver corresponding to the printing apparatus by looking up the table, and generates the print data by the activated printer driver.

6. The system according to claim 1, wherein the printing status includes a name of print data, a user who designated execution of printing, and a print processing status in said printing apparatus.

7. The system according to claim 6, wherein the print processing status includes at least one of completion of printing, during printing, and waiting for printing.

8. An information processing apparatus which generates print data to be printed by a printing apparatus based on a file attached to an e-mail transmitted from a mobile terminal, and transmits the print data to the printing apparatus, comprising:
a reception unit configured to receive the e-mail transmitted from the mobile terminal;
a generation unit configured to generate print data corresponding to a file attached to the e-mail received by said reception unit;
an extraction unit configured to extract an e-mail address of a transmission source of the e-mail; and
a transmission unit configured to add the e-mail address extracted by said extraction unit to the print data and transmit the print data to the printing apparatus.

9. A printing apparatus which prints based on print data received from an information processing apparatus defined in claim 8, comprising:
a display unit configured to display a printing status in the printing apparatus based on an e-mail address added to the print data transmitted from a transmission unit.

10. A method of controlling a printing system including an information processing apparatus and a printing apparatus, the printing apparatus printing based on a file attached to an e-mail transmitted from a mobile terminal, comprising:
a generation step of causing the information processing apparatus to generate print data corresponding to a file attached to the e-mail transmitted from the mobile terminal;
an extraction step of causing the information processing apparatus to extract an e-mail address of a transmission source of the e-mail;
a transmission step of causing the information processing apparatus to add the e-mail address extracted in the extraction step to the print data and transmit the print data to the printing apparatus; and
a display control step of causing the printing apparatus to display a printing status in the printing apparatus based on the e-mail address.

11. A method of controlling an information processing apparatus which generates print data to be printed by a printing apparatus based on a file attached to an e-mail transmitted from a mobile terminal, and transmits the print data to the printing apparatus, comprising:
a generation step of generating print data corresponding to the file attached to the e-mail transmitted from the mobile terminal;
an extraction step of extracting an e-mail address of a transmission source of the e-mail; and
a transmission step of adding the e-mail address extracted in the extraction step to the print data and transmitting the print data to the printing apparatus.

12. A computer-readable storage medium storing a program for causing a computer to execute
a generation step of generating print data corresponding to a file attached to an e-mail transmitted from a mobile terminal,
an extraction step of extracting the e-mail address of a transmission source of the e-mail, and
a transmission step of adding the e-mail address extracted in the extraction step to the print data and transmitting the print data to a printing apparatus.
